(19) United States
(12) Patent Application Publication
(10) Pub. No.: US 2016/0096142 A1
(43) Pub. Date: Apr. 7, 2016

(54) METHOD OF MAKING HOLLOW FIBER MEMBRANE MODULES WITH A CURABLE COMPOSITION AND MODULES MADE THEREFROM

(71) Applicant: H.B. FULLER COMPANY, ST. PAUL, MN (US)

(72) Inventors: JOEL M. HARRIS, BLAINE, MN (US); DORIAN P. NELSON, ST. PAUL, MN (US); MICHAEL S. MOREN, SHOREVIEW, MN (US); CHRISTINE M. GRIESE, HUDSON, WI (US); ALBERT M. GIORGINI, LINO LAKES, MN (US); BRIAN W. CARLSON, WOODBURY, MN (US)

(21) Appl. No.: 14/872,514

(22) Filed: Oct. 1, 2015

Related U.S. Application Data
(60) Provisional application No. 62/058,646, filed on Oct. 1, 2014.

(51) Int. Cl. B01D 63/02; B29C 65/00

(52) U.S. Cl. CPC B01D 63/023; B29C 65/002; B01D 63/02; B29L 2022/00

(57) ABSTRACT

A method of making hollow fiber filtration modules including potting an end portion of a plurality of hollow fiber membranes with a multi-pack, solvent-free curable composition. The curable composition includes a Michael donor, a Michael acceptor, and a Michael reaction catalyst.

This application claims the benefit of U.S. Provisional Application No. 62/058,464 filed, Oct. 1, 2015, which is incorporated herein.

### FIELD OF THE INVENTION

The invention relates to a multi-pack, solvent-free curable composition that is obtainable by a Michael reaction of a Michael donor with a Michael acceptor in the presence of a suitable catalyst, its use in the field of filtration technology, specifically in making hollow fiber filtration applications, and method of making the same.

### BACKGROUND OF THE INVENTION

A hollow fiber membrane module is a filtration device that can be used in precision filtration and ultrafiltration. In one exemplified configuration, the module includes a plurality of porous hollow fiber membranes that are introduced into a cylindrical container (housing), and potted at least one, or both end portions of the membranes inside the housing or a predetermined fixing container (e.g., cartridge head) with a cured resin material known as a potting composition.

Two-part curable compositions based on polyurethane and epoxy chemistries have been used as potting compositions for making hollow fiber membrane modules.

### SUMMARY OF THE INVENTION

The present invention relates to a multi-pack, solvent-free, ambient temperature curable composition that has low toxicity (i.e., isocyanate-free) and has appropriate characteristics (e.g., foam-free and low exotherm) when cured, making it suitable for use in filtration applications and in particular as a potting composition for potting hollow fiber membrane modules.

In one aspect, the invention features a method of making a hollow fiber membrane module. The method includes preparing a mixture of a multi-pack solvent-free curable composition by combining a multi-functional Michael donor, a multi-functional Michael acceptor, and a Michael reaction catalyst; introducing the mixture of the curable composition into at least one end portion of a plurality of hollow fiber membranes; and allowing the curable composition to solidify and cure, thereby potting the end portion of the plurality of hollow fiber membranes.

In one embodiment, the curable composition further includes up to less than 10% by weight of a filler.

In some embodiments, the curable composition exhibits an initial viscosity from 200 centipoise (cP) to 10,000 cP at 25° C., and a Shore A hardness of no less than 50 after cured for 7 days at 25° C. and 50% relative humidity.

In one embodiment, the catalyst has a conjugate acid that has a pKa of greater than 11.

In another aspect, the invention features a hollow fiber membrane module. The module includes a plurality of hollow fiber membranes having at least one end portion potted with a potting composition. The potting composition includes a reaction product of a multi-functional Michael donor, a multi-functional Michael acceptor, and a Michael reaction catalyst.

Conventional polyurethane based potting compositions for potting hollow fiber membranes require that the hollow fibers be dried prior to potting to remove residual moisture, which causes bubbling (or foaming) in the compositions once the compositions are applied to the end portion(s) of the membranes and prior to cure. Foaming decreases the filtration capabilities and can lead to failure of the module. To dry the fibers first prior to potting is costly and sometimes not even allowed with certain fibers that require a large amount of glycerin to sustain pore openings as the glycerin interferes with the reaction between isocyanates and polyols. Epoxy based potting systems have the limitation of producing a high exotherm (e.g., greater than 120° C.) cure profile causing charring of the hollow fibers or breakage of the filtration module.

In addition to meeting the requirements generally imposed in filtration applications and in particular, potting hollow fiber membranes, such as, appropriate initial viscosity and gel time to allow for the penetration of the composition into the hollow fiber membranes once the composition is applied to at least one end portion of the membranes, excellent chemical resistance to strong acidic and basic solutions, appropriate pot life, high hardness, etc., the multi-pack solvent-free curable composition of the invention also exhibits low exotherm temperature, and non-foaming behavior in the presence of moisture. These characteristics are especially beneficial in the manufacture of hollow fiber membrane modules for water filtration applications.

Further objects of the present invention will become clear from the further description hereinafter.

### BRIEF DESCRIPTION OF THE DRAWINGS

FIG. 1 is a cross-sectional view of one embodiment of the hollow fiber membrane module of the invention.

### GLOSSARY

In reference to the invention, these terms have the meanings set forth below:

“Michael reaction” refers to the addition reaction of a carbanion or nucleophile and an activated α,β-unsaturated carbonyl compound or group. A “Michael reaction” is a well-known reaction for the formation of carbon-carbon bonds and involves the 1,4-addition of a stabilized carbanion to an α,β-unsaturated carbonyl compound.

“Michael donor” refers to a compound with at least one Michael donor functional group, which is a functional group containing at least one Michael active hydrogen atom, which is a hydrogen atom attached to a carbon atom that is located between two electron-withdrawing groups such as C═O and/or C≡N, and/or NO₂ (nitro), and/or SO₂R (sulfone, R is an organic radical such as alkyl (linear, branched, or cyclic), aryl, heteroaryl, alkaryl, alkheteroaryl, and derivatives and substituted versions thereof).

“Michael acceptor” refers to a compound with at least one Michael acceptor functional group with the structure (I):

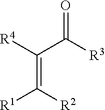

where R¹, R², R³ and R⁴ are, independently, hydrogen or organic radicals such as alkyl (linear, branched, or cyclic), aryl, alkaryl, and derivatives and substituted versions thereof. R¹, R², R³ and R⁴ may or may not, independently, contain alkoxy, aryloxy, ether linkages, carboxyl groups, further carbonyl groups, thio analogs thereof, nitrogen-containing groups, or combinations thereof.

“Michael acceptor” also refers to a compound with at least one Michael acceptor functional group with the structure (II):

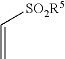

where R⁵ is an organic radical such as alkyl (linear, branched, or cyclic), aryl, heteroaryl, alkaryl, alkheteroaryl, and derivatives and substituted versions thereof. R⁵ may or may not, independently, contain ether linkages, carboxyl groups, further carbonyl groups, sulfonyl groups, thio analogs thereof, nitrogen-containing groups, or combinations thereof.

“Gel time” refers to the time for a curable composition to achieve a gelled state at which the composition is no longer workable.

“Equivalent weight” is defined as the molecular weight of a compound divided by the number of reactivities or functionalities of the compound that are relevant to the Michael reaction.

“Ambient temperature” refers to a temperature of 25° C.+/−5° C.

“(Meth)acrylate” refers to acrylate or methacrylate; and “(meth)acrylic” refers to acrylic or methacrylic.

### DETAILED DESCRIPTION OF THE INVENTION

The present disclosure relates to a multi-pack, solvent-free curable composition as a potting compound and its use for potting at least one end portion of a plurality of hollow fiber membranes.

### Curable Composition

The curable composition includes a Michael donor, a Michael acceptor, and a Michael reaction catalyst, and is a multi-pack system. That is, the composition includes two or more parts as herein described. The ingredient(s) in each part is stored in a container (pack) separate from the others until the contents of all the containers are mixed together to form the mixture of the curable composition prior to the application. Upon applying and curing, a solid adhesive forms that adheres hollow fiber membranes together. The phrase “multi-pack” is interchangeable herein with the phrase “multi-part”.

The curable composition is an isocyanate-free (NCO-free) and solvent-free composition based on acetoacetylated polymers obtainable through a Michael reaction between a Michael donor (e.g., acetoacetylated compound(s)) and a Michael acceptor (e.g., (meth)acrylate(s)) in the presence of a Michael reaction catalyst.

The curable composition is a liquid right after all the parts of the composition are mixed at an ambient temperature, e.g., 25° C.+/−5° C. Herein, a composition or a component is considered to be a liquid if it is liquid at an ambient temperature, e.g., 25° C.+/−5° C.

The curable composition is formulated to exhibit an initial viscosity of no greater than 10,000 centipoise (cP), or from 200 cP, or from 400 cP, or from 500 cP to no greater than 10,000 cP, or no greater than 4,000 cP, or no greater than 2,500 cP, or no greater than 1,500 cP at 25° C. Initial viscosity of the curable composition herein refers to the viscosity determined within 1 minute (min) to 5 min after all the parts of the composition are combined.

In some embodiments, the curable composition exhibits a gel time of from 5 minutes (min), or from 15 min to 120 min. or to 60 min, or to 30 min from the combination of all the parts of the composition.

The curable composition is formulated to be foam-free and exhibits low exotherm temperature. In some embodiments, the curable composition exhibits a maximum exotherm temperature of no greater than 120° C., or no greater than 100° C., or no greater than 80° C.

The curable composition is also formulated to exhibit high hardness. In some embodiments, the curable composition exhibits a Shore A hardness of no less than 50, or no less than 60, or no less than 70 after cured for 7 days at 25° C. and 50% relative humidity. In some embodiments, the curable composition exhibits a Shore D hardness of no less than 40, or no less than 50 after cured for 7 days at 25° C. and 50% relative humidity.

The curable composition is also formulated to exhibit resistance to chemicals such as cleaning/sanitizing reagents e.g., caustic, bleach, acidic or peroxide reagents during harsh chemical cleaning cycles. In some embodiments, the curable composition exhibits less than 5% weight change after soaking in an acidic or a caustic solution for 28 days according to the herein described Chemical Resistance Test Method.

In addition, the curable composition has other advantages. For example, the curable composition is solvent-free, therefore, it does not include any volatile organic compounds (VOCs).

The curable composition has a workable viscosity and pot life and also cures quickly to develop a high hardness within 24 hours after the multi parts are combined. Finally, the curable composition provides a strong adhesive bond that is resistant to humidity and chemicals.

In the curable compositions of the present invention, the relative proportion of multi-functional Michael acceptor(s) to multi-functional Michael donor(s) can be characterized by the reactive equivalent ratio, which is the ratio of the number of all the functional groups (e.g., in Structure I and/or Structure II) in the curable mixture to the number of Michael active hydrogen atoms in the mixture. The Michael donor component and the Michael acceptor component are blended together immediately prior to the application such that the equivalent ratio of the Michael acceptor functional acrylate groups to the Michael donor active hydrogens is from 0.3, or from 0.5 to 1.5, or to 1.

Part A Multi-Functional Michael Donor

The Part A of the curable composition includes at least one multi-functional Michael donor. In some embodiments, Part A includes more than one multi-functional Michael donors. In some embodiments, Part A is a liquid at ambient temperature.

Suitable Michael donors include those that are in a liquid form at ambient temperature. Suitable Michael donors also include those that are in a solid form at ambient temperature. When a Michael donor in solid form is included in Part A, it is preferably mixed with a Michael donor in liquid form such that the Part A is a liquid at ambient temperature.

A “Michael donor” is a compound with at least one Michael donor functional group.

Examples of Michael donor functional groups include malonate esters, acetoacetate esters, malonamides, acetoacetamides (in which Michael active hydrogens are attached to the carbon atom between two carbonyl groups), cyanoacetate esters and cyanoacetamides (in which Michael active hydrogens are attached to the carbon atom between the carbonyl group and the cyano group). A Michael donor may have one, two, three, or more separate Michael donor functional groups. Each Michael donor functional group may have one or two Michael active hydrogen atoms. A compound with two or more Michael active hydrogen atoms is known herein as a multi-functional Michael donor. The total number of Michael active hydrogen atoms on the donor molecule is known as the functionality of the Michael donor. A Michael donor is a compound composed of Michael donor functional group(s) and a skeleton (or core). As used herein, the “skeleton (or core) of Michael donor” is the portion of the donor molecule other than the Michael donor functional group(s).

Particularly preferred multi-frictional Michael donors include acetoacetylated polyols. The polyols being acetoacetylated have at least one hydroxyl group, and preferably have two or more hydroxyl groups. The conversion of hydroxyl groups to acetoacetate groups should be between 80 mol % and 100 mol % and more preferably between 85 mol % and 100 mol %.

A method for making acetoacetylated polyols is well known in the art, such as Journal of Organic Chemistry 1991, 56, 1713-1718. “Transacetoacetylation with tert-Butyl Acetoacetate Synthetic Applications”, in which the acetoacetylated polyol can be prepared by transesterification with an alkyl acetoacetate, e.g., tert-butyl acetoacetate.

In some embodiments, the multi-functional Michael donor is an acetoacetylated polyol that includes at least one acetoacetoxy functional group, and a skeleton of Michael donor selected from the group consisting of a polyether polyol, a polyester polyol, a polycarbonate polyol, a polybutadiene polyol, polyurethane polyol, urethane polyol, a glycol, a mono-hydric alcohol, a polyhydric alcohol, a natural oil polyol, and modifications thereof, and combinations thereof.

Examples of suitable polyhydric alcohols as skeletons for the multi-functional Michael donor (as well as for the below multi-functional Michael acceptor in Part B) include e.g., alkane diols, alkylene glycols, glycerols, sugars, pentaerythritols, polyhydric derivatives thereof, cyclohexane dimethanol hexane diol, castor oil, castor wax, trimethylolpropane, ethylene glycol, propylene glycol, pentacrythritol, trimethylolethane, ditrimethylolpropane, dipentaerythritol, glycerin, dipropylene glycol, N,N,N′,N′-tetrakis(2-hydroxypropyl)ethylendiamine, neopentyl glycol, propanediol, butanediol, diethylene glycol, and the like.

Examples of more preferred polyols include trimethylolpropane (TMP), isosorbide, glycerol, neopentyl glycol (NPG), butyl ethyl propane diol (BEPD), tricyclodecane dimethanol, 1,4-cyclohexanedimethanol, hydroquinone bis(2-hydroxyethyl) ether, castor oil, castor wax, polybutadiene, polyester polyols, and polyether polyols.

Examples of Michael donors include but are not limited to methyl acetoacetate, ethyl acetoacetate, n-propyl acetoacetate, isopropyl acetoacetate, n-butyl acetoacetate, t-butyl acetoacetate, ethylene glycol bisacetoacetate, 1,2 propanediol bisacetoacetate, 1,3 propanediol bisacetoacetate, 1,4 butanediol bisacetoacetate, neopentyl glycol bisacetoacetate, isosorbide bisacetoacetate, trimethylolpropane tris acetoacetate, glycerol tris acetoacetate, castor oil tris acetoacetate, castor wax tris acetoacetate, glucose tris acetoacetate, glucose tetraacetoacetate, sucrose acetoacetates, sorbitol tris acetoacetate, sorbitol tetra acetoacetate, acetoacetates of ethoxylated and propoxylated diols, triols and polyols such as ethoxylated neopentyl glycol bisacetoacetate, propoxylated glucose acetoacetates, propoxylated sorbitol acetoacetates, propoxylated sucrose acetoacetates, polyester acetoacetates in which the polyester is derived from at least one diacid and at least one diol, polyesteramide acetoacetates in which the polyesteramide is derived from at least one diacid and at least one diamine, 1,2 ethylene bisacetamide, 1,4 butane bisacetamide, 1,6 hexane bisacetoacetamide, piperazine bisacetamide, acetamides of amine terminated polypropylene glycols, acetamides of polyesteramides acetoacetates in which the polyesteramide is derived from at least one diacid and at least one diamine, polyacrylates containing comonomers with acetoacetoxy functionality (such as derived from acetoacetoxyethyl methacrylate), and polyacrylates containing acetoacetoxy functionality and silylated comonomers (such as vinyl trimethoxysilane).

Part B Multi-Functional Michael Acceptor

The Part B of the curable composition includes at least one multi-functional Michael acceptor. In some embodiments, Part B includes more than one multi-functional Michael acceptors. In some embodiments, Part B is a liquid at ambient temperature.

A “Michael acceptor” is a compound having at least one acceptor functional group as described above. A compound with two or more Michael acceptor functional groups is known herein as a multi-functional Michael acceptor. The number of functional groups on the acceptor molecule is the functionality of the Michael acceptor. As used herein, the “skeleton of the Michael acceptor” is the portion of the acceptor molecule other than the functional group(s).

The multi-functional Michael acceptor may have any of a wide variety of skeletons. Examples of the skeleton of the multi-functional Michael acceptor include a polyhydric alcohol (such as, those listed herein above in Part A Michael donor section), a polymer such as, a poly alkylene oxide, a polyurethane, a polyethylene vinyl acetate, a polyvinyl alcohol, a polybutadiene, a hydrogenated polybutadiene, an alkyd, an alkyd polyester, a (meth)acrylic polymer, a polyolefin, a polyester, a halogenated polyolefin, a halogenated polyester, or combinations thereof.

Preferably, the multi-functional Michael acceptor is a multi-functional (meth)acrylate, which includes monomers, oligomers, polymers of the multi-functional (meth)acrylate, and combinations thereof.

Examples of multi-functional (meth)acrylates suitable as the multi-functional Michael acceptor include 1,4-butanediol diacrylate, 1,6-hexanediol diacrylate, neopentyl glycol diacrylate, diethylene glycol diacrylate, triethylene glycol diacrylate, tetraethylene glycol diacrylate, polyethylene glycol diacrylate, dipropylene glycol diacrylate, tripropylene glycol diacrylate, cyclohexane dimethanol diacrylate, alkoxylated hexanediol diacrylate, alkoxylated cyclohexane dimethanol diacrylate, propoxylated neopentyl glycol diacrylate, trimethylolpropane triacrylate, ethoxylated trimethylolpropane triacrylate, propoxylated trimethylolpropane triacrylate, acrylated polyester oligomer, bisphenol A diacrylate, ethoxylated bisphenol A diacrylate, tris(2-hydroxyethyl) isocyanurate triacrylate, acrylated aliphatic urethane oligomer, acrylated aromatic urethane oligomer, and the like, and combinations thereof.

Other examples of suitable multi-functional (meth)acrylates include tetraethylene glycol dimethacrylate, trimethylolpropane trimethacrylate, ditrimethylolpropane-tetraacrylate, ditrimethylolpropane-tetramethacrylate, pentacrythritol tetraacrylate, pentacrythritol tetramethacrylate and the like. In accordance with the present invention, a curable composition can additionally contain mono α,β-unsaturated compounds such as a monoacrylate.

Further examples of suitable multi-functional Michael acceptors include multi-functional (meth)acrylates in which the skeleton is polymeric. The (meth)acrylate groups may be attached to the polymeric skeleton in a wide variety of ways. For example, a (meth)acrylate ester monomer may be attached to a polymerizable functional group through the ester linkage, and that polymerizable functional group may be polymerized with other monomers in a way that leaves the double bond of the (meth)acrylate group intact. For another example, a polymer may be made with functional groups (such as, a polyester with residual hydroxyls), which may be reacted with a (meth)acrylate ester (for example, by transesterification) to yield a polymer with pendant (meth)acrylate groups. For yet another example, a homopolymer or copolymer may be made that includes a multi-functional (meth)acrylate monomer (such as trimethylolpropane triacrylate) in such a way that not all the acrylate groups react.

Mixtures or combinations of suitable multi-functional Michael acceptors are also suitable.

Examples of suitable commercially available multi-functional Michael acceptors include multi-functional polyester acrylates under the trade designations CN292, CN2283, CN2207, and CN2203; polyethylene glycol diacrylate under the trade designation SR344; ethoxylated bisphenol A diacrylates under the trade designations SR349, SR601 and SR602; tricyclodecane dimethanol diacrylate under the trade designation SR833 S; hexafunctional aromatic urethane acrylate under the trade designation CN 975; trifunctional urethane acrylate under the trade designation CN 929; and aliphatic polyester based urethane hexa-acrylate under the trade designation CN968, all of which are available from Sartomer USA, LLC (Exton, Pa.).

It is believed that reacting a Michael donor having functionality of 2 with a Michael acceptor having a functionality of 2 will lead to linear molecular structures. To create molecular structures that are branched and/or crosslinked, one would use at least one ingredient having a functionality of 3 or greater. Therefore, it is preferred that either the multi-functional Michael donor or the multi-functional Michael acceptor or both have a functionality of 3 or greater.

In the practice of the present invention, the skeleton of the multi-functional Michael acceptor may be the same or different from the skeleton of the multi-functional Michael donor.

Michael Reaction Catalyst

The curable composition also includes a Michael reaction catalyst. A Michael reaction catalyst is a catalyst that is capable of initiating a Michael reaction. The catalyst may be included in Part A, or Part B, or combination thereof.

Alternatively, the catalyst may be provided to the curable composition as a separate component, such as a Part C.

The catalyst is present in the curable composition in an amount from 0.1%, or from 0.5% to 10%, or to 1.5%, based on the mole of Michael active hydrogen atoms.

Useful Michael reaction catalysts include both strong base catalysts, of which the conjugated acid has a pKa of greater than 11; and weak base catalysts, of which the conjugated acid has a pKa of from 4 to 11. Examples of suitable strong base catalysts include guanidines, amidines, and combinations thereof such as 1,1,3,3-tetramethylguanidine (TMG), 1,8-Diazabicyclo(5.4.0)undec-7-ene (DBU), and 1,5-Diazabicyclo(4.3.0)non-5-ene (DBN). Examples of suitable weak base catalysts include tertiary amines, alkali metal carbonates, alkali metal bicarbonates, alkali metal hydrogen phosphates, phosphines, alkali metal salts of carboxylic acids including but not limited to triethylamine, sodium carbonate, potassium carbonate, sodium bicarbonate, potassium bicarbonate, potassium hydrogen phosphate (mono-basic and di-basic), and potassium acetate. Examples of other Michael reaction catalysts include triphenyl phosphine, triethyl phosphine, and tributyl phosphine.

In some embodiments, the Michael reaction catalyst is a strong base catalyst, of which the conjugated acid preferably has a pKa of greater than 11, or from 12 to 14. Preferably the bases are organic. Examples of such bases include amindines and guanidines. More preferred catalysts include 1,1,3,3-tetramethylguanidine (TMG), 1,8-diazabicyclo-[5.4.0]undes-7-ene (DBU), and 1,5-diazabicyclo[4,3,0]non-5-ene (DBN).

Part D Combination of Multi-functional Michael Donor and Multi-functional Michael Acceptor

In some embodiments, the multi-functional Michael donor(s) and acceptor(s) can be placed together in one pack, and the Michael reaction catalyst can be placed in another pack. The two packs are mixed together immediately before the application.

Therefore, in some embodiments, the adhesive composition includes a Part D and a Part C. Part D includes a combination of any one of the herein described Part A and any one of the herein described Part B. Part C includes any one of the herein described Michael reaction catalysts. The Part D and Part C are mixed together immediately before the application.

In some embodiments, Part D includes a dual functional compound that includes a Michael donor functionality and a Michael acceptor functionality. The dual functional compound can be a dual functional monomer, a dual functional oligomer, a dual functional polymer, and combinations thereof.

Other Additives

The curable composition may also include other optional additives in any part(s) of the multi-pack curable composition, which include antioxidants, plasticizers, adhesion promoters, catalysts, catalyst deactivators, colorants (e.g., pigments and dyes), surfactants, waxes, defoamers, diluents (including reactive diluents), tackifiers, reinforcing fillers, tougheners, impact modifiers, stabilizers e.g., triethyl phosphate, and combinations thereof.

In some embodiments, the curable composition may include up to less than 10%, or up to less than 5%, or from 1% to 3% by weight of a filler, based on the weight of the curable composition. The filler may be included in any part(s) of the multi-pack curable composition. Examples of suitable fillers include fume silica, calcium carbonate, and combinations thereof.

### Method of Making and Using

The curable composition of the invention is a multi-pack composition. That is, the composition includes two or more parts; the ingredient(s) in each part is stored in a container (pack) separate from the others until the contents of all the containers are mixed together to form the mixture of the curable composition prior to the application. Each individual pack of the multi-pack composition is storage stable. Mixing of all the packs together may be performed at ambient temperature or at elevated temperature.

The curable composition of the invention is useful for potting porous hollow fiber membranes together to make hollow fiber membrane modules.

The hollow fiber membranes typically have two end portions.

In one embodiment, the hollow fiber membranes are potted at one end portion of the membranes with a potting composition that is a reaction product of any one of the aforementioned multi-pack, solvent-free curable compositions of the invention. In particular, the potting composition includes a reaction product of a multi-functional Michael donor, a multi-functional Michael acceptor, and a Michael reaction catalyst.

In another embodiment, the hollow fiber membranes are potted at both end portions of the membranes with a potting composition that is a reaction product of a multi-functional Michael donor, a multi-functional Michael acceptor, and a Michael reaction catalyst.

In some embodiments, the hollow fiber membranes may be potted with one layer of the potting composition that is a reaction product of a multi-functional Michael donor, a multi-functional Michael acceptor, and a Michael reaction catalyst.

In some embodiments, the hollow fiber membranes may be potted with more than one layer of the potting compositions, in which at least one of the potting compositions is the potting composition that is a reaction product of a multi-functional Michael donor, a multi-functional Michael acceptor, and a Michael reaction catalyst.

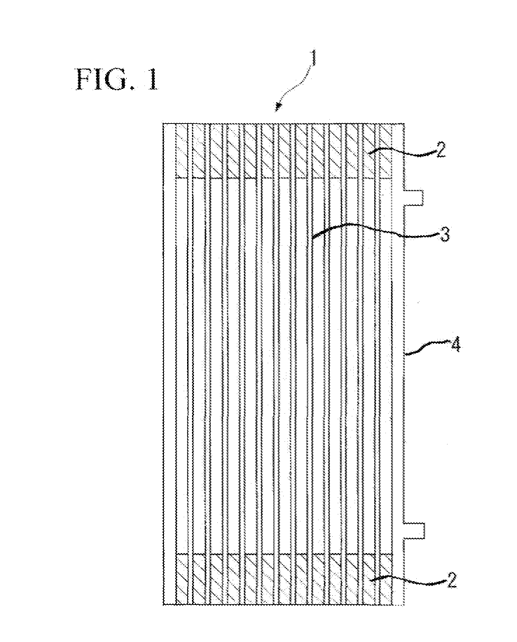

As one embodiment, FIG. 1 illustrates a hollow fiber membrane module 1. The module 1 includes a plurality of porous hollow fiber membranes 3 contained in a cylindrical housing 4. In this embodiment, the hollow fiber membranes 3 are potted inside the housing 4 at both end portions of the membranes 3 with a potting composition 2. The potting composition 2 includes a reaction product of any one of the aforementioned multi-pack, solvent-free curable compositions of the invention.

Any suitable method of potting at least one end portion of a plurality of hollow fiber membranes can be used to make the membrane modules.

In one embodiment, a hollow fiber membrane module is fabricated including the steps of introducing end portions of a plurality of porous hollow fiber membranes into a predetermined container (e.g., housing), preparing a mixture of the curable composition of the invention, introducing the mixture of the curable composition into the container, allowing the curable composition to flow and permeate around the end portion, solidifying and curing the curable composition, thereby potting the end portion of the hollow fiber membranes. The preparation of the mixture includes combining all parts of the curable composition together immediately before the curable composition is applied.

Useful application temperatures range from 20° C. to 50° C. or from 20° C. to 35° C. Lower temperatures are preferred during the application process in order to extend the working life of the curable composition.

The invention encompasses various hollow fiber membrane filtration modules along with methods for making and using the same through any of the aforementioned curable compositions of the invention. The configuration of the hollow fiber membrane module is not particularly limited. Examples of various hollow fiber membrane filtration modules in which the curable composition of the present invention is particularly useful include those constructions and methods of making thereof described in, e.g., U.S. Pat. No. 8,758,621; U.S. Pat. No. 8,518,256; U.S. Pat. No. 7,931,463; U.S. Pat. No. 7,022,231; U.S. Pat. No. 7,005,100; U.S. Pat. No. 6,974,554; U.S. Pat. No. 6,648,945; U.S. Pat. No. 6,290,756; US2006/0150373; which are incorporated herein by reference in their entirety.

The present disclosure may be further understood with reference to the following examples. These examples are intended to be representative of specific embodiments of the disclosure and are not intended to be limiting to the scope of the disclosure.

All parts, ratios, percents, and amounts stated herein and in the examples are by weight unless otherwise specified.

### EXAMPLES

### Test Methods

### Viscosity

The viscosity is determined using a Brookfield DV-II+Pro viscometer from Brookfield Engineering, USA, using Spindle #27 at 2 rpm (revolutions per minute) and 12 grams of a sample material at 25° C.±5° C. or 30° C.±5° C., and 50% relative humidity.

### Glass Transition Temperature (T_{g})

The glass transition temperature (T_{g}) of a cured composition is determined according to ASTM D-3418-83 entitled “Standard Test Method for Transition Temperatures of Polymers by Differential Scanning Calorimetry (DSC)” with conditioning a sample at 140° C. for two minutes, quench cooling the sample to −60° C. and then heating the sample to 140° C. at a rate of 20° C. per minute. The reported T_{g} is the temperature at which onset of the phase change occurs.

### Shore A Hardness

Shore A hardness of a cured composition is determined using a hand held hardness meter from Paul N. Gardner Company, Inc. USA, and Shore A scale at 25° C.±5° C. and 50% relative humidity. The cured composition is cured for 7 days at 25° C.±5° C. and 50% relative humidity.

### Shore D Hardness

Shore D hardness of a cured composition is determined using a hand held hardness meter from Paul N. Gardner Company, Inc. USA, and Shore D scale at 25° C.±5° C. and 50% relative humidity. The cured composition is cured for 7 days at 25° C.±5° C. and 50% relative humidity.

### Gel Time

The gel time of a multi-pack curable composition is determined using a Gardco Standard Gel Timer (from Paul N. Gardner Company, Inc., USA) at 25° C.±5° C. and 50% relative humidity. A 110 gram mixture of Part A (Michael donor and Michael reaction catalyst) and Part B (Michael acceptor) is mixed and deposited in an aluminum dish in the timer unit, a wire stirrer is inserted, the display is set to zero and the timer is turned on. The gel timer stirs until gel occurs (the viscosity of the mixture increases to a point where the drag exceeds the torque of the motor and the motor stops), stopping the timer and stirrer. The time on the timer is recorded as the gel time in minutes.

### Chemical Resistance Test Method

Chemical resistance is determined as follows:

Test specimens are prepared by making 10 gram pucks of a curable two-part (Michael donor and Michael acceptor) composition. The pucks of the composition are cured at 25° C.+5° C. and 50% relative humidity for 7 days. The cured specimens are weighed and the initial weight is recorded. The cured specimens are soaked in either acidic or basic conditions for a duration of 28 days. For acidic conditions three cured puck specimens are soaked in a pH 1 solution (0.1M HCl) at 25° C.±5° C. and 50% relative humidity for 28 days. For basic conditions the three cured puck specimens are soaked in a pH 12 solution (NaOH_{aq}) at 40° C.±5° C. and 50% relative humidity. After 7, 14, 21, and 28 days the pucks are removed from the test solution, rinsed off with deionized water at ambient temperature, dried for one hour, weight recorded, and re-soaked in the appropriate fresh solution. Chemical resistance is reported as the percent % weight change (weight loss or weight gain) of the cured puck specimens

Exotherm

The exotherm of a multi-pack curable composition is determined by mixing in a plastic beaker a 100 gram mixture of Part A (Michael donor and Michael reaction catalyst) and Part B (Michael acceptor) and measuring, after mixing, the temperature and time of the mixture using a standard digital thermometer. The exotherm is recorded as the maximum (max) temperature (° C.) the mixture achieves as it cures.

### Bubble Formation Test Method

The formation of bubbles of a multi-pack, solvent-free adhesive composition is determined by mixing a 100 g mixture of part A (donor and catalyst) and part B (acceptor) and allowing the mixture to cure at 25° C.±5° C. and 50% relative humidity for 7 days. After cure the composition is visually inspected for the formation of bubbles. The absence of bubbles within the cured composition is a pass. The appearance of bubbles within the cured composition constitutes a fail.

### Michael Donor

The following Michael donors were used for making the curable composition to be tested in the Examples:

### Donor 1 (D-1) (Acetoacetoxy Trimethylolpropane (AATMP)

Donor 1 was prepared by adding trimethylolpropane and tert-butyl acetoacetate (TBAA) to a reaction kettle equipped with a stirrer and a distillation column connected to a vacuum line. Amounts of the polyol and TBAA were used to provide a desired conversion degree of the polyol with 100 mol % conversion using TBAA in a molar excess of ⅓. The reaction was carried out at 120° C. for 2 hours and tert-butanol by-product was collected by distillation. The reaction was continued at this temperature until no more tert-butanol was collected. The reaction was cooled to ambient temperature, vacuum was applied and the reaction was heated to 120° C. over 1 hour to collect any residual tert-butanol and tert-butylacetoacetate. The reaction was heated at 125° C. for 3-4 hours or until no further tert-butanol or tert-butylacetoacetate was collected. The acetoacetylated polyol was cooled and stored for use.

### Donor 2 (D-2) (Tri-Acetoacetate of VORANOL 230-660)

Donor 2 was prepared according to the procedure as that in D-1, except that VORANOL 230-660 (polyether polyol, commercially available from Dow Chemical) was used instead of trimethylolpropane.

### Donor 3 (D-3) (a Mixture of 75% by Weight of D-1 and 25% by Weight of Di-Acetoacetate of VORANOL 220-056N)

Donor 3 was prepared by mixing 75% by weight of D-1 and 25% by weight of di-acetoacetate of VORANOL 220-056N. Di-acetoacetate of VORANOL 220-056N was prepared according to the procedure as that in D-1, except that VORANOL 220-056N (polyether polyol, commercially available from Dow Chemical) was used instead of trimethylolpropane.

### Donor 4 (D-4)

Donor 4 (D-4) was prepared according to the procedure as that in D-1, except that K-FLEX® UD-320-100 (a polyurethane diol commercially available from King Industries (Norwalk, Conn.)) was used instead of trimethylolpropane.

### Michael Acceptor

The following Michael acceptors were used for making the curable composition to be tested in the Examples:

Acceptor 1 (A-1): Multi-functional polyester acrylate oligomer (CN 292 available from Sartomer USA, LLC).
Acceptor 2 (A-2): Ethoxylated (10) bisphenol A diacrylate (SR 602 available from Sartomer USA, LLC).
Acceptor 3 (A-3): Multi-functional polyester acrylate oligomer (CN 2283 available from Sartomer USA, LLC).
Acceptor 4 (A-4): Ethoxylated (4) bisphenol A diacrylate (SR 601 available from Sartomer USA, LLC).
Acceptor 5 (A-5): 90% SR 602 and 10% aliphatic polyester based urethane hexa-acrylate oligomer (CN968 available from Sartomer USA, LLC).
Acceptor 6 (A-6): 90% SR 602 and 10% hexafunctional aromatic urethane acrylate oligomer (CN975 available from Sartomer USA, LLC).
Acceptor 7 (A-7): 20% CN 292, 60% SR833 S (tricyclodecane dimethanol diacrylate, available from Sartomer USA, LLC), and 20% CN 929 (trifunctional urethane acrylate available from Sartomer USA, LLC).

### Acceptor 8 (A-8): 20% CN 292, 75% SR833 S, and 5% CN 929.

### Acceptor 9 (A-9): 25% CN 292, 50% SR833 S, and 25% CN 929.

### Michael Reaction Catalyst

The following Michael reaction catalyst was used for making the curable composition to be tested in the Examples:

1,8-diazabicyclo[5.4.0.]undec-7-ene (DBU, available from Air Products).

### Examples 1-15 and Comparative Examples 1-2

Each curable composition of Examples 1-15 and Comparative Examples 1-2 was prepared by combining Part A and Part B according to Table 1 at ambient temperature prior to the testing, and then was tested according to the herein described various test methods. The results are listed in Tables 1 and 2.

TABLE 1

| | | | Mix Ratio | Shore | Shore | |
|---|---|---|---|---|---|---|
| | | | by Weight | A | D | T_{g} |
| | Part A | Part B | (A:B) | (±5) | (±5) | (° C.) |
| Comp. | *UR2187A | *UR2187B | 1:0.625 | 90 | 54 | 15 |
| Ex. 1 | | | | | | |
| Comp. | **FE7811A | **FE7811B | 1:0.53 | N/A*** | 80 | |
| Ex. 2 | | | | | | |
| Ex. 1 | D-1, | A-1 | 1:3.21 | 96 | 55 | 17 |
| | 1.5% DBU | | | | | |
| Ex. 2 | D-1, | A-1 | 1:3.15 | 94 | 42 | 16 |
| | 1.5% DBU | | | | | |
| | 2% fumed | | | | | |
| | silica | | | | | |
| Ex. 3 | D-1 | A-2 | 1:5.93 | 86 | 30 | −3 |
| | 1.5% DBU | | | | | |
| Ex. 4 | D-1 | A-2 | 1:5.82 | 83 | 26 | |
| | 1.5% DBU | | | | | |
| | 2% fumed | | | | | |
| | silica | | | | | |
| Ex. 5 | D-1 | A-1 | 1:3.05 | 96 | 55 | |
| | 1.5% DBU | | | | | |
| | 2% fumed | | | | | |
| | silica | | | | | |
| Ex. 6 | D-2 | A-1 | 1:2.45 | 89 | 44 | −18 |
| | 1.5% DBU | | | | | |
| Ex. 7 | D-2 | A-3 | 1:3.15 | 81 | 20 | −26 |
| | 1.5% DBU | | | | | |
| Ex. 8 | D-3 | A-4 | 1:2.15 | 95 | 62 | 24 |
| | 1.5% DBU | | | | | |
| Ex. 9 | D-1 | A-5 | 1:5.55 | 83 | 25 | −8 |
| | 1.25% | | | | | |
| | DBU | | | | | |
| Ex. 10 | D-1 | A-6 | 1:5.55 | 79 | 20 | −7 |
| | 1.25% | | | | | |
| | DBU | | | | | |
| Ex. 11 | D-1 | A-7 | 1:3.3 | 100 | 84 | 37 |
| | 1.2% DBU | | | | | |
| Ex. 12 | D-4 | A-7 | 1:1.8 | 100 | 70 | 24 |
| | 1.2% DBU | | | | | |
| Ex. 13 | D-1 | A-8 | 1:2.5 | 100 | 84 | 40 |
| | 1.2% DBU | | | | | |
| Ex. 14 | D-1 | A-9 | 1:3.6 | 100 | 74 | 33 |
| | 1.2% DBU | | | | | |
| Ex. 15 | D-1 | A-7 | 1:1.75 | 95 | 50 | |
| | 1.2% DBU | | | | | |

*Two-part polyurethane adhesive commercially available from H. B. Fuller (St. Paul, MN).
**Two-part epoxy adhesive commercially available from H. B. Fuller.
***Not applicable.

TABLE 2

| | | Gel | Exo- | | | |
|---|---|---|---|---|---|---|
| | Initial | Time | therm | Chemical | | |
| | Viscosity | (min at | Max | Resistance* | | Bubble |
| | (cP at | 25° C.) | Temp | pH = 1 (at | pH = 12 (at | For- |
| | 25° C.) | (±5 min) | (° C.) | 25° C.) | 40° C.) | mation |
| Comp. | 900 | 40-75 | 50 | pass | pass | Yes |
| Ex 1. | | | | | | |
| Comp. | 450 | 66-80 | 107 | pass | pass | No |
| Ex. 2 | | | | | | |
| Ex. 1 | 500 | 35 | 59 | pass | pass | No |
| Ex. 2 | 1500 | 32 | 47 | NT** | NT | No |
| Ex. 3 | 650 | 79 | 37 | pass | pass | No |
| Ex. 4 | 1000 | 72 | 34 | NT | NT | No |
| Ex. 5 | 2000 | NT | NT | NT | NT | No |
| Ex. 6 | 450 | 187 | 33 | pass | pass | No |
| Ex. 7 | 125 | 233 | 33 | pass | pass | No |
| Ex. 8 | 1200 | 22 | 46 | pass | pass | No |
| Ex. 9 | 875 | 94 | 34 | NT | NT | No |
| Ex. 10 | 750 | 62 | 38 | NT | NT | No |
| Ex. 11 | 1150 | 41 | 78 | pass | pass | no |
| Ex. 12 | 2500 | 60 | 71 | pass | pass | no |
| Ex. 13 | 1100 | 44 | 82 | pass | pass | no |
| Ex. 14 | 1900 | 42 | 60 | pass | pass | no |
| Ex. 15 | 1050 | 65 | 81 | pass | pass | no |

*Pass: less than 5% weight gain or loss.
**NT: not tested.

The above specification, examples and data provide a complete description of the disclosure. Since many embodiments can be made without departing from the spirit and scope of the disclosure, the invention resides in the claims hereinafter appended.

We claim:

1. A method of making a hollow fiber membrane module, comprising:
preparing a mixture of a multi-pack, solvent-free curable composition by combining a multi-functional Michael donor, a multi-functional Michael acceptor, and a Michael reaction catalyst,
introducing the mixture of the curable composition into at least one end portion of a plurality of hollow fiber membranes, and
allowing the curable composition to solidify and cure, thereby potting the end portion of the plurality of hollow fiber membranes.

2. The method of claim 1, wherein the curable composition further comprises from 0 to less than 10% by weight filler, based on the weight of the curable composition.

3. The method of claim 1, wherein the curable composition exhibits an initial viscosity of from 200 centipoise (cP) to 10,000 cP at 25° C.

4. The method of claim 1, wherein the multi-functional Michael donor comprises an acetoacetylated polyol that has at least one acetoacetoxy functional group, and a skeleton selected from the group consisting of a polyether polyol, a polyester polyol, a polycarbonate polyol, polyurethane polyol, urethane polyol, a polybutadiene polyol, a glycol, a mono-hydric alcohol, a polyhydric alcohol, a natural oil polyol, and modifications thereof, and combinations thereof.

5. The method of claim 1, wherein the multi-functional Michael acceptor is selected from the group consisting of monomers, oligomers, and polymers of multi-functional (meth)acrylate, and combinations thereof.

6. The method of claim 5, wherein the multi-functional Michael acceptor comprises multi-functional polyester acrylates, ethoxylated bisphenol A diacrylates, urethane acrylate oligomers, polyethylene glycol diacrylates, tricyclodecane dimethanol diacrylates, and combinations thereof.

7. The method of claim 6, wherein the curable composition exhibits, upon cure, non-foaming behavior in the presence of moisture.

8. The method of claim 6, wherein urethane acrylate oligomers comprises hexafunctional aromatic urethane acrylate oligomers, aliphatic polyester based urethane hexa-acrylate oligomers, and combinations thereof.

9. The method of claim 1, wherein the catalyst is a strong base catalyst having a conjugate acid that has a pKa of greater than 11.

10. The method of claim 1, wherein the catalyst comprises amindines and guanidines.

11. The method of claim 9, wherein the catalyst comprises 1,1,3,3-tetramethylguanidine (TMG), 1,8-diazabicyclo-[5.4.0]undes-7-ene (DBU), and 1,5-diazabicyclo[4,3,0]non-5-ene (DBN).

12. The method of claim 1, wherein the curable composition exhibits a maximum exotherm temperature of no greater than 120° C.

13. The method of claim 1, wherein the equivalent ratio of Michael acceptor functional group acrylates to Michael donor active hydrogens is from 0.3:1 to 1.5:1.

14. The method of claim 1, wherein the catalyst is in an amount of from 0.1% to 10% based on the mole of Michael active hydrogen atoms.

15. The method of claim 1, wherein the curable composition exhibits a gel time of from 3 minutes to 120 minutes.

16. The method of claim 1, wherein the curable composition exhibits a Shore A hardness of no less than 50 after cured for 7 days at 25° C. and 50% relative humidity.

17. The method of claim 1, wherein the curable composition exhibits a Shore D hardness of no less than 40 after cured for 7 days at 25° C. and 50% relative humidity.

18. A hollow fiber membrane module, comprising
a plurality of hollow fiber membranes having at least one end portion potted with a potting composition,
wherein the potting composition comprises a reaction product of
a multi-functional Michael donor,
a multi-functional Michael acceptor, and
a Michael reaction catalyst.

19. The hollow fiber membrane module of claim 18, wherein the potting composition exhibits a Shore A hardness of no less than 50 after cured for 7 days at 25° C. and 50% relative humidity.

20. The hollow fiber membrane module of claim 18, wherein the potting composition exhibits non-foaming behavior in the presence of moisture.
